(19) United States
(12) Patent Application Publication
(10) Pub. No.: US 2006/0243776 A1
(43) Pub. Date: Nov. 2, 2006

(54) Part for active silver brazing and active silver brazing product using the part

(76) Inventors: Kaoru Tada, Kanagawa (JP); Mitsuo Kawai, Kanagawa (JP)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/565,330

(22) PCT Filed: Jul. 14, 2004
(86) PCT No.: PCT/JP04/10022

§ 371 Date: Jan. 19, 2006

(30) Foreign Application Priority Data
Jul. 22, 2003 (JP) 2003-300598
Aug. 25, 2003 (JP) 2003-341823
Aug. 25, 2003 (JP) 2003-341824

(51) Int. Cl. A47J 36/02

(52) U.S. Cl. 228/101

(57) ABSTRACT

Brazed product obtained by brazing a metal and ceramic according to a brazing method of high production rate that realizes uniform brazing material composition at brazed sites, thereby enhancing junction reliability and that is free from problems such as deterioration of working environment by malodor. There are also disclosed a ceramic part and metal part for use in the production of the brazed product. The brazed product is produced by applying a binder to brazing site of at least one of a metal part made of a metal and a ceramic part made of a ceramic; spreading active silver braze powder and fixing the same thereto; overlapping the brazing site with the bonding face of the counterpart member; and heating them in a furnace to melt the active silver braze powder and brazing therewith. The parts for brazing of the present invention are a ceramic part and a metal part having a binder applied onto brazing site of at least one of the metal and ceramic and having active silver braze powder spread on and fixed to the binder.

### TECHNICAL FIELD

The present invention relates to a brazed product produced by brazing a metal and a ceramic with an active silver braze, particularly to a heat sink to be used for releasing heat for a semiconductor device. The present invention also relates to a part to be used for producing such brazed product (a ceramic part for brazing or a metal part for brazing).

### BACKGROUND ART

Conventionally, as a heat sink for releasing heat of a semiconductor device, those produced by a method, so-called direct bonding, of joining a copper plate and a plate of alumina, aluminum nitride, or silicon nitride are employed.

Recently, the output of a semiconductor device is increased and along with that, heat release tends to be insufficient since the copper plate cannot be thickened in the case of the heat sink produced by the conventional direct bonding method and there occurs a problem that high electric current cannot be applied.

As a method of producing a heat sink comprising a thick copper plate, a method for brazing a copper plate and a ceramic plate with so-called active silver braze, a silver braze containing titanium, zirconium, and hafnium has been known. Further, as a method for brazing a ceramic and a metal, a method for brazing a metal by metallizing the face of a ceramic to be brazed and using a silver braze and another brazing material has conventionally been known, however this method requires the process of the metallization treatment.

Generally, an active silver braze is inferior in the ductility and is thus difficult to produce a thin sheet or a foil by rolling and therefore, a paste type active silver braze obtained by kneading a silver powder and a copper powder with a titanium or titanium hydride powder in an organic solvent type binder is generally used and brazing is carried out by applying the paste type active silver braze to an joining face of a metal or a ceramic and then heating and melting it in a furnace. Also, paste type active silver braze materials using a silver braze powder, which is an alloy of silver and copper, in place of the silver powder and copper powder, and paste type active silver braze materials using powders of other active metals and their compounds in place of the titanium hydride powder have been developed. Further, paste type active silver braze materials obtained by melting active metals such as titanium, zirconium, or other active metals with silver and copper, atomizing the molten metals for obtaining an alloy powder as an active silver braze powder, and kneading the active silver braze powder with a binder have been developed.

As a method for applying a paste type active silver braze to an object part to be brazed of a metal or a ceramic is known, a method using a dispenser or a method of screen printing. It is difficult, however, for the method using a dispenser to apply the paste type active silver braze thin and evenly and therefore, the screen printing method is generally employed.

According to the screen printing method, however, if a copper plate or a ceramic plate becomes thick, it becomes difficult to prevent dripping of the paste type brazing material to the outer circumferential part at the time of an application work and also it requires additional work for removing the paste brazing material adhering to the squeegee and a screen.

For that, as a method for solving such application inconveniences of the paste type active silver brazing materials by the dispenser or the screen printing method, production of a thin sheet or a foil of an active silver braze containing an active metal such as titanium or zirconium about 2% by weight and a brazing method of inserting it between a ceramic and a metal and heating in a furnace have been investigated.

However, alloys containing an active metal such as titanium are inferior in ductility and cracks are formed at the time of rolling, there is an industrial problem for producing the thin sheet or foil of an alloy containing the active metal.

### DISCLOSURE OF THE INVENTION

It is an object of the present invention to solve the problems of the case of application of a paste type active silver braze by a conventional dispenser or screen printing method, and to provide a brazed product of brazed metals and ceramics by an industrially excellent method at a high production speed and a heat sink excellent in thermal conductivity.

Further, it is an another object of the present invention to solve the problems of the case of brazing metals and ceramics using the paste type active silver braze or a thin sheet or foil of the active silver brazing material, and to provide an industrially useable ceramic part for active silver brazing and a metal part for active silver brazing.

A brazed product of the present invention is a brazed product obtained by brazing a metal part made of a metal and a ceramic, in which the brazing is carried out by applying a binder to at least an object portion to be brazed of one of the metal part and the ceramic part; spreading and firmly depositing an active silver braze powder containing the following components a) to c),
a) silver,
b) copper, and
c) at least one of titanium, zirconium, indium, and tin on the binder; overlapping a corresponding portion to be brazed of a counterpart member thereon; and heating the both in a furnace to melt the active silver braze powder and brazing therewith.

The above-mentioned brazed product of the present invention is characterized in that the active silver braze powder is produced by an atomization method and the ratio of the active silver braze powder having a particle diameter of 10 μm to 100 μm is 90% or more.

Further, the above-mentioned brazed product of the present invention is characterized in that the metal part is made of copper or a copper alloy, and the ceramic part is made of aluminum nitride or silicon nitride, and the brazed product is a heat sink for releasing heat of a semiconductor device.

A brazed part of the present invention is characterized in that the part is made of a metal or a ceramic and is to be used for producing a brazed product comprising by brazing a metal or a ceramic, and a binder is applied to at least an object portion to be brazed of one of the metal part and the ceramic part, and an active silver braze powder containing the following components a) to c),
a) silver,
b) copper, and
c) at least one of titanium, zirconium, indium, and tin is spread and firmly deposited on the binder.

### BEST MODES FOR CARRYING OUT OF THE INVENTION

The reason for application of a binder to the face to be joined of one of a metal or a ceramic is to firmly deposit the active silver braze powder on the face to be joined, and organic solvent type binders may be used, however since the organic solvent type binders worsen the working environments by the malodor, a water-soluble binder is desirable, and an aqueous ethylene glycol solution and an aqueous polyvinyl alcohol solution can be exemplified.

In the present invention, the reason for the active silver braze powder is spread and firmly deposited on the binder after the binder is applied is because as compared with a case of using a conventional paste type active silver braze, the use amount of the binder can be lessened and therefore, the gas evolution at the time of brazing can be suppressed and formation of pin holes and blow holes in the joined part after brazing can be suppressed.

The time to be taken for applying the binder and spreading the active silver braze powder can be shortened as compared with the time taken in the case of using a paste type brazing material, and mass production is made possible.

Various kinds of methods have been known as the method of applying the binder, and spraying of the binder is simple and quick for finishing the work and therefore, it is industrially desirable. As the application state of the binder in the spraying method, it is desirable to disperse the binder uniformly in granular state. The active silver braze powder can be uniformly dispersed and firmly deposited on the joining face by uniformly dispersing the binder in granular state.

The reason for that the binder and the active silver braze powder are not spread simultaneously is because the recovery and reuse of the active silver braze powder can be made easy.

In the case a slurry type active silver braze obtained by previously mixing the binder and the active silver braze powder is sprayed and applied, the slurry type active silver braze scattered to other than the portion to be brazed adheres to a powder braze application apparatus to make the recovery and reuse difficult. In the case a powder braze application apparatus manufactured by US Wall Colmonoy Co. is used, the binder and the powder brazing material are separately supplied to the powder braze material application apparatus, however simultaneously with spraying of the binder, the powder braze material is spread and mixed, and therefore, recovery and reuse of the active silver braze powder scattered to other than the part for brazing becomes difficult.

The reason for use of the active silver braze powder is because in the case a silver powder, a copper powder, and either titanium or titanium hydride are successively spread on the binder, the number of applications is increased and the treatment time is prolonged and also, the use amount of the binder is increased and it is industrially undesirable. In the case a mixture of a silver powder, a copper powder, and either titanium or titanium hydride is spread to the binder, it becomes difficult to carry out uniform spreading because of the difference of the particle diameter and specific gravity of the respective components.

As the active silver braze powder of the present invention is desirable a spherical powder produced by dissolving a) silver, b) copper, and c) at least one of titanium, zirconium, indium, and tin in respectively prescribed amounts and atomizing the mixture because of easily spreading on the binder.

In the case an element such as indium or tin is contained in the active silver braze powder, the melting point is lowered and therefore the working temperature (melting temperature) at the time of brazing can be lowered to bring an advantage that the remaining stress of the brazed part can be suppressed. Oxygen and nitrogen are desirable to be less since they deteriorate the brazing property and practically the both are preferably 0.05% or lower.

Hereinafter, preferable alloy systems of the active silver braze powder in the present invention will be described.

1) Ag-Cu-In-Ti alloy

In this case, Cu is preferably 20 to 30% and more preferably 23 to 28%: In is preferably 2 to 16% and more preferably 3 to 15%: and Ti is preferably 1 to 3% and more preferably 1.5 to 2.5%. This alloy containing added In has a low melting point as compared with a following Ag-Cu-Ti alloy containing no In and therefore is advantageous for brazing at a low temperature.

2) Ag-Cu-Sn-Ti alloy

In this case, Cu is preferably 20 to 35%; Sn is preferably 2 to 15%; and Ti is preferably 1 to 3% and more preferably 1.5 to 2.5%. This alloy containing added Sn also has a low melting point as compared with a following Ag-Cu-Ti alloy containing no Sn and therefore is advantageous for brazing at a low temperature.

3) Ag-Cu-Ti alloy

In this case, Cu is preferably 20 to 35% and Ti is preferably 1 to 3% and more preferably 1.5 to 2.5%.

In the present invention, as the active silver braze powder, an alloy powder of which 90% has a particle diameter of 10 μm to 100 μm is used, and the reason for that is because in the case of a fine powder of the particle size of 10 μm or smaller, the fine powder is scattered and the recovery of the powder is difficult and in the case of a coarse powder with a particle size of 100 μm or larger, the coarse powder spread and firmly deposited on the brazing face become disperse and it becomes difficult to carry out excellent brazing. The particle diameter of the active silver braze powder in the present invention is desirably 20 μm to 80 μm.

In the present invention, the method for producing a ceramic part for brazing or a metal part for brazing by firmly depositing the active silver braze powder to the brazing face of a ceramic or a metal may be carried out by spraying a binder to the brazing face of the ceramic or the metal by a spray and then spreading the active silver braze powder thereon by a feeder apparatus using vibration such as an electromagnetic vibrator and then drying them. The times to be taken to spray the binder and to spread the active silver braze powder can considerably be shortened as compared with that of a screen printing method using a paste type active silver braze material and thus mass production is made possible. In the part for brazing of the present invention, the active silver braze powder is firmly deposited in an amount per unit surface area of the brazing face in a range of 0.004 g/cm² or more and more preferably 0.01 to 0.03 g/cm².

In the present invention, the reason for the preference of copper or a copper alloy for the metal to be brazed is because it has excellent thermal conductivity and electric conductivity. The reason for the preference of aluminum nitride or silicon nitride as the ceramic to be brazed is because it has excellent thermal conductivity and electric insulation property needed for a heat sink for releasing heat of a semiconductor device.

It is made easy to carry out brazing of a metal and a ceramic with the active silver braze by fitting a brazing face of a counterpart member to the brazing face of the part for brazing of the present invention (the ceramic part for brazing or the metal part for brazing) where the active silver braze powder is firmly deposited. In this case, the brazing temperature may properly be selected in accordance with the composition of the active silver braze powder and it is generally 750 to 900° C.

Hereinafter the present invention will be described more in detail with reference to examples.

### EXAMPLE 1

An active silver braze powder was produced by melting an alloy containing copper 27.4%, titanium 1.8%, and balance silver and inevitable impurities in argon atmosphere and spraying the molten metal by an atomizing method. The powder was classified by a classifying apparatus to obtain four groups of powders different in the particle size distribution as shown in Table 1. Then, a commercialized water-soluble binder (an aqueous polyvinyl alcohol solution) was sprayed by a spray to a copper plate of 25×25×0.5 mm and each of the classified active silver braze powders was spread by an electromagnetic feeder. After that, the active silver braze powder which was not deposited on the binder was removed and the binder was dried and the weight of the active silver braze powder firmly deposited on the copper plate was weighed, and at the same time, the powder spreading state was inspected with eye observation. The results are shown in Table 1.

TABLE 1

| | | Powder | |
|---|---|---|---|
| | Particle diameter | spreading | Powder |
| Classification | distribution | state | weight |
| 1 | 45 μm or smaller | Nonuniform | 0.07 g |
| | (containing 10 μm or | | |
| | smaller in 20% or more | | |
| | ratio) | | |
| 2 | 10 μm to 100 μm | Uniform | 0.09 g |
| 3 | 20 μm to 80 μm | Uniform | 0.09 g |
| 4 | 45 μm or larger | Uniform, | 0.10 g |
| | (containing 100 μm or | disperse | |
| | larger in 20% or more | | |
| | ratio) | | |

From these results, the active silver braze powder containing fine powder with a particle diameter of smaller than 10 μm could not be well spread and the active silver braze powder containing fine powder with a particle diameter of larger than 100 μm was distributed sparsely although it could be spread by using a feeder and therefore, it could be not well expected, good brazing could not be done with these powders. In this connection, in the case an alumina plate was used in place of the copper plate, similar results were obtained.

### EXAMPLE 2

Square rods of aluminum nitride and oxygen-free copper square with 20 mm square size each were prepared and an active silver braze powder containing copper 23.7%, titanium 2.2%, indium 14.2%, oxygen 0.02%, and nitrogen not more than 0.001%, and balance silver and inevitable impurities and having a particle diameter of 20 μm to 80 μm was produced by an atomizing method.

The above-mentioned commercialized water-soluble binder was sprayed by a spray to the 20 mm square face of the oxygen-free copper rod and then the above-mentioned active silver braze powder 0.08 g was spread and firmly deposited on the binder. Next, the 20 mm square face of the aluminum nitride was butted to the face in which the active silver braze powder was spread and deposited and they were heated in a vacuum furnace at 7500° C. for carrying out brazing. A specimen was sampled from the obtained brazed product and subjected to a bending test according to JIS. As a result, although the aluminum nitride was broken, no abnormality was observed in the brazed part, proving that the brazing was well done. In this connection, similar results were obtained also in the case the binder was spray coated to the surface of the aluminum nitride and then the active silver braze powder was spread and firmly deposited thereon and then brazing with the oxygen-free copper face was carried out.

### EXAMPLE 3

Square rods of silicon nitride and oxygen-free copper square with 20 mm square size each and an active silver braze powder containing copper 27.4%, titanium 1.8%, oxygen 0.02%, and nitrogen not more than 0.001%, and balance silver and inevitable impurities and having a particle diameter of 20 μm to 80 μm were prepared.

The above-mentioned commercialized water-soluble binder was sprayed by a spray to the 20 mm square face of the oxygen-free copper rod and then the above-mentioned active silver braze powder 0.09 g was spread and firmly deposited on the binder. Next, the 20 mm square face of the silicon nitride was butted to the face in which the active silver braze powder was spread and deposited and they were heated in a vacuum furnace at 830° C. for carrying out brazing. A specimen was sampled from the obtained brazed product and subjected to a bending test according to JIS. As a result, although the silicon nitride was broken, no abnormality was observed in the brazed part, proving that the brazing was well done.

In this connection, similar results were obtained also in the case the binder was spray coated to the surface of the silicon nitride and then the active silver braze powder was sprayed and firmly deposited thereon and then brazing with the oxygen-free copper face was carried out.

### EXAMPLE 4

Aluminum nitride of 25×25×0.6 mm size and oxygen-free copper of 25×25×1 mm size were prepared, and an active silver braze powder containing copper 24.5%, titanium 2.1%, indium 13.8%, oxygen 0.03%, and nitrogen 0.001%, and balance silver and inevitable impurities and having a particle diameter of 20 μm to 80 μm was also prepared.

The commercialized water-soluble binder was sprayed by a spray to the 25 mm square face of the oxygen-free copper and then the above-mentioned active silver braze powder 0.09 g was spread and firmly deposited on the binder. Next, the aluminum nitride was butted to the face in which the active silver braze powder was sprayed and deposited and they were heated in a vacuum furnace at 750° C. for carrying out brazing.

The joined part of the obtained brazed part was monitored by ultrasonic examination to find there was no pin hole or blow hole and that the brazing was well done.

### EXAMPLE 5

Aluminum nitride of 25×25×0.6 mm size and oxygen-free copper of 25×25×1 mm size were prepared, and an active silver braze alloy powder containing copper 26.7%, titanium 2.0%, tin 4.8%, oxygen 0.03%, and nitrogen 0.001%, and balance silver and inevitable impurities and having a particle diameter of 20 μm to 80 μm was also prepared.

The commercialized water-soluble binder was sprayed by a spray to the 25 mm square face of the oxygen-free copper, and then the above-mentioned active silver braze alloy powder 0.10 g was spread and firmly deposited on the binder. Next, the aluminum nitride was butted to the face in which the active silver braze alloy powder was spread and deposited and they were heated in a vacuum furnace at 800° C. for carrying out brazing.

The joined part of the obtained brazed part was monitored by ultrasonic examination to find there was no pin hole or blow hole and that the brazing was well done.

### COMPARATIVE EXAMPLE

Square rods of aluminum nitride and oxygen-free copper square with 20 mm square size each and an active silver braze powder containing copper 25.7%, indium 7.6%, oxygen 0.02%, and nitrogen not more than 0.001%, and balance silver and inevitable impurities and having a particle diameter of 20 μm to 80 μm were prepared.

The above-mentioned commercialized water-soluble binder was sprayed by a spray to the 20 mm square face of the oxygen-free copper and then the above-mentioned active silver braze powder 0.09 g was spread and firmly deposited on the binder. Next, the 20 mm square face of the aluminum nitride was butted to the face in which the active silver braze powder was sprayed and deposited and they were heated in a vacuum furnace at 790° C., however brazing could not be carried out.

### Industrial Application

The ceramic part and the metal part for active silver braze of the present invention can be produced by mass production at a high speed as compared with that of the case of using a paste type active silver braze without being accompanied with troubles in the case of producing a brazed part by conventional brazing method, and since the chemical composition of the active silver braze in the brazed part is uniform, the ceramic part and the metal part for active silver braze of the present invention can be used for brazing with high bonding reliability of the brazed part, which is industrially very useful.

1. A brazed product obtained by brazing a metal part made of a metal and a ceramic part made of a ceramic, wherein brazing is carried out by applying a binder to at least an object portion to be brazed of one of the metal part and the ceramic part; spreading and firmly depositing an active silver braze powder containing the following components a) to c),
a) silver,
b) copper, and
c) at least one of titanium, zirconium, indium, and tin on the binder; overlapping a corresponding portion to be brazed of a counterpart member thereon; and heating the both in a furnace to melt the active silver braze powder and brazing therewith.

2. The brazed product according to claim 1, wherein the active silver braze powder is produced by an atomization method and the ratio of the active silver braze powder having a particle diameter of 10 μm to 100 μm is 90% or more.

3. The brazed product according to claim 1, wherein the metal part is made of copper or a copper alloy, the ceramic part is made of aluminum nitride or silicon nitride, and the brazed product is a heat sink for releasing heat of a semiconductor device.

4. A part for brazing made of a metal or a ceramic and to be used for producing a brazed product by brazing a metal and a ceramic, wherein the part is obtained by applying a binder to at least an object portion to be brazed of one of the metal part and the ceramic part, and spreading and firmly depositing an active silver braze powder containing the following components a) to c),
a) silver,
b) copper, and
c) at least one of titanium, zirconium, indium, and tin on the binder.
